(19) United States
(12) Patent Application Publication
(10) Pub. No.: US 2014/0149330 A1
(43) Pub. Date: May 29, 2014

(54) CONTEXTUAL KNOWLEDGE MANAGEMENT SYSTEM AND METHOD

(71) Applicants: Elon Kaplan, Ramat Hasharon (IL); Haggai Zohar, Herev Le'et (IL)

(72) Inventors: Elon Kaplan, Ramat Hasharon (IL); Haggai Zohar, Herev Le'et (IL)

(21) Appl. No.: 14/069,161

(22) Filed: Oct. 31, 2013

Related U.S. Application Data
(60) Provisional application No. 61/731,061, filed on Nov. 29, 2012.

(51) Int. Cl. G06N 5/02

(52) U.S. Cl. CPC G06N 5/022
USPC 706/46

(57) ABSTRACT

A computer-based method for personal knowledge management, the method comprising using one or more hardware processors for: detecting copying of data from a source document by the user, on a computer; intercepting the copied data in a clipboard of the computer; collecting and storing in a knowledge database one or more contextual parameter associated with the copied data; upon attempted pasting of the copied data by the user, injecting at least one of said one or more contextual parameter into the clipboard, such that when the copied data is pasted into a target document, said at least one of said one or more contextual parameter is pasted into the target document along with the copied data; executing one or more data retrieval tools to retrieve knowledge from the knowledge database responsive to a query by the user; and displaying one or more records retrieved from the knowledge database to the user.

### CROSS-REFERENCE TO RELATED APPLICATION(S)

This application claims priority to and the benefit of U.S. Provisional Application No. 61/731,061, filed Nov. 29, 2012, the entire contents of which are incorporated herein by reference.

### FIELD OF THE INVENTION

The invention relates to a contextual knowledge management system.

### BACKGROUND

Knowledge management systems, as defined by Encyclopedia Britannica, “provide a means to assemble and act on the knowledge accumulated throughout an organization”. See Encyclopedia Britannica Online, s. v. “Information System”, accessed Oct. 9, 2012, http://www.britannica.com/EBchecked/topic/287895/information-system/218054/Operational-support-and-enterprise-systems. Knowledge management systems, however, are not the exclusive domain of organizations; such computerized systems and tools are broadly used by individuals for their own personal needs, as well as by individuals contributing to public information databases.

Knowledge management systems have traditionally required structured and deliberate input, editing and sometimes even taxonomy of information by contributors. This process saw some progress in the late 2000's, with the emergence of Web 2.0 technologies and practices. Tools such as Wikis, blogs, social sharing services, group-messaging software and the like have made both public databases and corporate intranets into a constantly changing structure built by distributed, autonomous peers—a collaborative platform that reflects the way work really gets done. See McAfee, Andrew P., “Enterprise 2.0: The Dawn of Emergent Collaboration”. 2006. MIT Sloan Management Review 47 (3): 21-28.

Still, some argue that, while technology is no longer a real barrier for knowledge management in developed economies, “vast servers of knowledge sit underutilized with out-of-date or irrelevant content that does not support current business objectives”. See Capozzi, Marla M., “Knowledge Management Architectures Beyond Technology”, 2007, First Monday 12 (6). Capozzi suggests that the notion of technological knowledge management “architecture” be expanded to also include the architecture of human interactions, as “insights and distinctive knowledge are far more likely to be created between and among people, and less so when people interact individually with technology-based content.” This approach, while probably having some truth to it, is an indication of a common belief in the exhaustion of knowledge management technology used for gathering knowledge produced by people who interact individually with computers.

There is therefore an unmet need in the field of knowledge management for technologies that enhance the way knowledge is gathered from such individually-interacting people. A further unmet need is for technologies for intelligent, contextual retrieval of the gathered knowledge.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a computer-based method for personal knowledge management, the method comprising using one or more hardware processors for: detecting copying of data from a source document by the user, on a computer; intercepting the copied data in a clipboard of the computer; collecting and storing in a knowledge database one or more contextual parameter associated with the copied data; upon attempted pasting of the copied data by the user, injecting at least one of said one or more contextual parameter into the clipboard, such that when the copied data is pasted into a target document, said at least one of said one or more contextual parameter is pasted into the target document along with the copied data; executing one or more data retrieval tools to retrieve knowledge from the knowledge database responsive to a query by the user; and displaying one or more records retrieved from the knowledge database to the user.

In some embodiments, said knowledge database is stored in a server accessible by the computer over a network.

In some embodiments, the method further comprises running a background service on the computer, wherein said detecting, intercepting, collecting and injecting are performed by said background service.

In some embodiments, said source document comprises a web page.

In some embodiments, said one or more contextual parameters are selected from the group consisting of characteristics of a web page, characteristics of the target document, date, time, geographic location of the computer, characteristics of a software and/or a hardware of the computer and demographic characteristics of the user.

In some embodiments, said collecting is performed fully-automatically, such that computer work of the user is not interrupted.

In some embodiments, said collecting is performed semi-automatically, and comprises (a) background collecting of at least one of said one or more contextual parameter, and (b) receiving from the user, via manual input, other at least one of said one or more contextual parameter.

In some embodiments, the method further comprises retaining said other at least one of said one or more contextual parameter for future use, such that future collecting is performed fully-automatically.

In some embodiments, at least one of said one or more contextual parameter is pasted into the target document as text, said at least one of said one or more contextual parameter being a printable part of said target document.

In some embodiments, said at least one of said one or more contextual parameter is pasted into the target document as hidden text, said at least one of said one or more contextual parameter not being a printable part of said target document.

In some embodiments, said copied data is pasted into said target document such that to form an actionable link to said source document.

In some embodiments, said copied data is pasted into said target document such that to form an actionable link to a location in said computer in which said copied data and said at least one of said one or more contextual parameter are stored.

In some embodiments, said one or more data retrieval tools are selected from the group consisting of: full-text search tools, semantic search tools, statistical engines and/or business intelligence tools.

In some embodiments, said one or more data retrieval tools is a semantic search engine.

In some embodiments, said knowledge database is used for training said semantic search engine.

There is further provided, in accordance with an embodiment, a computer-based method for organizational knowledge management, the method comprising: (a) for each of multiple members of an organization: detecting copying of data from a source document by a member of said multiple members the organization, on a computer; intercepting the copied data in a clipboard of the computer; collecting and storing in a knowledge database one or more contextual parameter associated with the copied data; upon attempted pasting of the copied data by the member, injecting at least one of said one or more contextual parameter into the clipboard, such that when the copied data is pasted into a target document, said at least one of said one or more contextual parameter is pasted into the target document along with the copied data; (b) executing one or more data retrieval tools to retrieve knowledge of at least some of said multiple members from the knowledge database, responsive to a query by a member of said multiple members; and (c) displaying one or more records retrieved from the knowledge database to the member.

There is yet further provided, in accordance with an embodiment, a computer-based method for global knowledge management, the method comprising: (a) for each of multiple Internet users: detecting copying of data from a source document by a user of said Internet users, on a computer; intercepting the copied data in a clipboard of the computer; collecting and storing in a knowledge database one or more contextual parameter associated with the copied data; upon attempted pasting of the copied data by the Internet users, injecting at least one of said one or more contextual parameter into the clipboard, such that when the copied data is pasted into a target document, said at least one of said one or more contextual parameter is pasted into the target document along with the copied data; (b) executing one or more data retrieval tools to retrieve knowledge of at least some of said Internet users from the knowledge database, responsive to a query by user of said multiple Internet users; and (c) displaying one or more records retrieved from the knowledge database to the user.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a flow chart of a computer-based method for collection of data and contextual parameters, in accordance with some embodiments;

FIG. 2 shows a flow chart of a computer-based method for personal, contextual knowledge management, in accordance with some embodiments;

FIG. 3 shows a flow chart of a computer-based method for organizational, contextual knowledge management, in accordance with some embodiments; and

FIG. 4 shows a flow chart of a computer-based method for global, contextual knowledge management, in accordance with some embodiments;

FIG. 5 shows a schematic illustration of a screenshot taken from an exemplary system;

FIG. 6 shows an exemplary schematic illustration of a screenshot of a web page from which a paragraph was copied and acted upon by the exemplary system;

FIG. 7 shows an exemplary schematic illustration of a screenshot of a “Clip Board Grid” of the exemplary system; and

FIG. 8 shows another exemplary schematic illustration of a screenshot of the “Clip Board Grid” of the exemplary system.

### DETAILED DESCRIPTION

Advantageous methods and systems for contextual knowledge management are disclosed herein. For purposes of the following discussions, it is first important to clearly define some core terms: “data”, “context” and “knowledge”. “Data” is anything that is recorded, such as in digital format or using other means. A subset of “data” is “structured data”, such as transaction data and data stored in a database for automated retrieval. Data that is not structured is “unstructured data”. Unstructured data includes data stored in a digital format or in some other format (e.g. paper, microfilm, etc.). Finally, “knowledge” is “data” in conjunction with “context”. Context may be defined as all information relevant to or associated with the gathering or composing of the data, the identity or characteristics of the person who gathers or composes the data, the decision being made by the person based on the data, his or her insights on the data, etc. Broadly speaking, any information existing in the consciousness of the person gathering/composing the data at the specific time of gathering/composing—is “context”.

Unfortunately, even when a person attempts to record his or her knowledge for future use, he or she will often find out that, while data can be retained quite easily using technological means, the retention of the data in context can be far trickier. Without proper recordation of context, deterioration of human memory over time makes it hard for the recorded data, even if successfully retrieved, to be put in the correct context again. Without context, the data is merely data and not real knowledge.

The methods and systems for contextual knowledge management presently disclosed enable the recordation, processing and retrieval (jointly referred to as “management”) of knowledge, namely—data plus context. According to present embodiments, data and context is collected from a user's computer, and optionally from associated external sources, in a fully- or semi-automatic manner. This minimizes or even eliminates disturbance to the user's normal flow of computer work. Advantageously, the collected context comprises multiple “contextual parameters” which, together with the data, allow the building of a meaningful, contextual knowledge database. The knowledge in the database enables later retrieval in a way that essentially restructures the user's past consciousness. The contextual parameters bring the data “back to life” again, and enable the user to go back, mentally, to the same time he or she conceived of the knowledge initially. Similarly, a different user retrieving the knowledge may benefit from entering the original user's shoes and gaining his or her retained experiences.

The presently-disclosed methods and systems for contextual knowledge management may be better understood by way of example. In an exemplary scenario, a user's computer work includes the composing of a certain document by gathering pieces of data (text, graphics, multimedia etc.) from online sources available through the Internet or the like, and optionally by creating original text, images and/or multimedia. The document is not necessarily being prepared for reasons of knowledge retention it may be any regular business (or other) document which may contain data worth retaining. The present contextual knowledge management system may automatically intercept the data being gathered online, such as by monitoring the computer's clipboard for data “copied and pasted” by the user. The system may then collect and store one or more contextual parameters, such as:

1. Characteristics of the online source—parameters which are not normally included in the clipboard during a copy operation. Such parameters may include: a uniform resource locator (URL), title of document, author, tags, description, location in the document of the excerpt being copied, and/or the like.

2. Characteristics of the “target” document, namely—the document being prepared by the user. For example: title, author, file name, tags, description, location in the document where the excerpt is being pasted, and/or the like.

3. Characteristics of the “copy and paste” event, such as: date, time, geographic location of the computer performing the work, characteristics of the computer's software/hardware, and/or the like.

4. Demographic characteristics of the user, such as: age, gender, place of residence, spoken languages, fields of interest, and/or the like. Other than such anonymous information, the name and/or other identifying information of the user may be collected.

As mentioned, these contextual parameters may be collected in a fully- or a semi-automatic manner. In a fully-automatic collection, all collection operations are being done in the background, without the user being interrupted and prompted to input information. However, some information may not be readily available for collection, which requires semi-automatic collection, in which information only known to the user is manually entered by him or her in response to a suitable prompt. Some contextual parameters, such as user demographics, user identity and/or others, may need to be entered by a user only once, such as upon installation of the present system, and can be retained in the system for attachment to all future collection operations.

According to present embodiments, once collected and stored in a knowledge database, later usage of the retained knowledge may be personal, organizational and/or even global. Personal use may include the running of queries using one or more full-text search tools, semantic search tools, statistical engines, business intelligence tools, etc., in order to retrieve knowledge from the knowledge database. Similarly, in an organizational or even a global setting, knowledge collected from multiple members of the organization (or multiple members of the public, such as Internet users) may be stored in a unified knowledge database, or in multiple interconnected databases; hence, one member's query may enable this member to retrieve and enjoy knowledge created by one or more other members.

As knowledge created by a large number of users accumulates in the contextual knowledge management system, further benefits of the system may come into play. The existence of a large and diverse body of knowledge, in which data appears in context, may serve as the basis for an advanced, semantic search engine. Much effort has been made in recent years in the development of sophisticated semantic search engines. See, for example, Grimes, Seth, “Breakthrough Analysis: Two+Nine Types of Semantic Search”, Information Week, Jan. 21, 2010, Accessed Mar. 25, 2012, http://www.informationweek.com/software/business-intelligence/breakthrough-analysis-two-nine-types-of/222400100. It has been said that the motivation to develop such search engines stems, to a great extent, from the shortcoming of traditional, so-called “full-text” search engines; full-text search engines determine which results are most relevant to the query mostly by analyzing and indexing the textual contents of documents. Some search engines also give weight to parameters external to the searched documents—such as to link structures between web pages, etc. Indeed, a major problem in many such traditional search engines is their dependence on text.

Texts, words, are merely data. Understanding the meaning of text normally requires a human. Computers can interpret and “understand” text in indirect methods, using techniques such as natural language processing (NLP) and others. Commonly, in order to allow for documents to be searched by a semantic search engine, the search engine has to undergo some form of automatic “training”, to verify that the automatically-generated semantic analysis is indeed correct. Such training is sometimes done by comparing the automated semantic analysis with human analysis. For this purpose, a database of structured human analysis of text may be of great help. Advantageously, the present knowledge database, which includes data put in context, may greatly enhance the training process of semantic search engines. The knowledge database, containing structured data in conjunction with contextual parameters, may assist in relaying the human-perceived meaning of words, phrases and texts in general to the search engine in training. Naturally, the larger the knowledge database is, the better training can be achieved. When the present system is used by a large number of members of an organization, or even better—by numerous Internet users, their collective knowledge may provide invaluable training to semantic search engines.

Reference will now be made to the figures, in which methods and systems are disclosed. Unless specifically stated otherwise, as apparent from the following discussions, it is appreciated that terms such as “processing”, “computing”, “calculating”, “determining”, or the like, refer to the action and/or process of a physical computing system or a similar electronic computing device, that manipulate and/or transform data represented as physical, such as electronic, quantities within the computing system's registers and/or memories into other data similarly represented as physical quantities within the computing system's memories, registers or other such.

Some embodiments may be implemented, for example, using a non-transitory computer-readable medium or article which may store an instruction or a set of instructions that, when executed by a computer (for example, by a hardware processor and/or by other suitable machines), cause the computer to perform a method and/or operations in accordance with present embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, such as C, C++, C#, Java, BASIC, Pascal, Fortran, Cobol, assembly language, machine code, or the like.

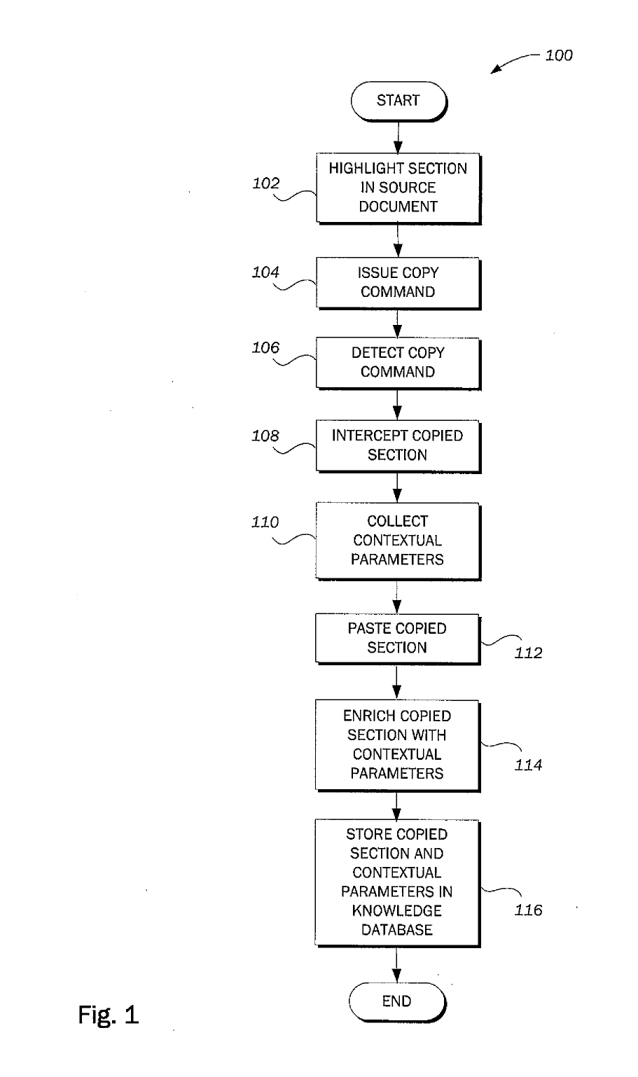

Reference is now made to FIG. 1, which shows a flow chart of a computer-based method 100 for collection of data and contextual parameters, in accordance with some embodiments. The present system may be configured to carry out method 100.

In a step 102, a user highlights (or otherwise marks) a section in a source document; the section includes “data”—such as text, graphics and/or multimedia content. The source document may be, for example, an online-available document such as a web page. It may also be a digital document of any type located on the user's computer, on the user's organizational network and/or the like.

In a step 104, the user issues a command to copy the highlighted section, and the section is then copied by the computer to its clipboard. In a step 106, the copy command is detected by the present system, which optionally runs on the computer as a background service, waiting for copy commands to happen. In a step 108, the system intercepts the copied section from the clipboard. Then, in a step 110, the system collects one or more contextual parameters based on the intercepted section. As discussed above, the collection may be automatic and/or may require the user to enter information manually. In addition, some contextual parameters may be entered by the user once, and be used automatically in all consecutive collection operations, or until changed by the user at a later time.

In a step 112, the user may paste the copied section to a target document he or she is composing in the course of his or her work. The target document may be stored locally on the user's computer or remotely, in an online document editing service. Optionally, in a step 114, the system enhances the paste operation by enriching the copied section with one or more of the contextual parameters collected. For example, if a URL of the source document was collected, the system may paste the URL along with the section. This may be done by injecting the URL to the clipboard prior to the user commanding the computer to paste the section. The pasting of the contextual parameters may be done either as text which will form a regular, printable part of the target document, and/or as hidden text which can be displayed to the user but does not form part of the printable document. As an additional or an alternative option, the section may be pasted and be defined to form an actionable link to the source document and/or to a suitable location in the system in which the present data and context are stored.

In a step 116, the copied section (data) and contextual parameters are stored in a knowledge database, which may be physically located on the user's computer, on a remote server (such as in “the cloud”) and/or the like.

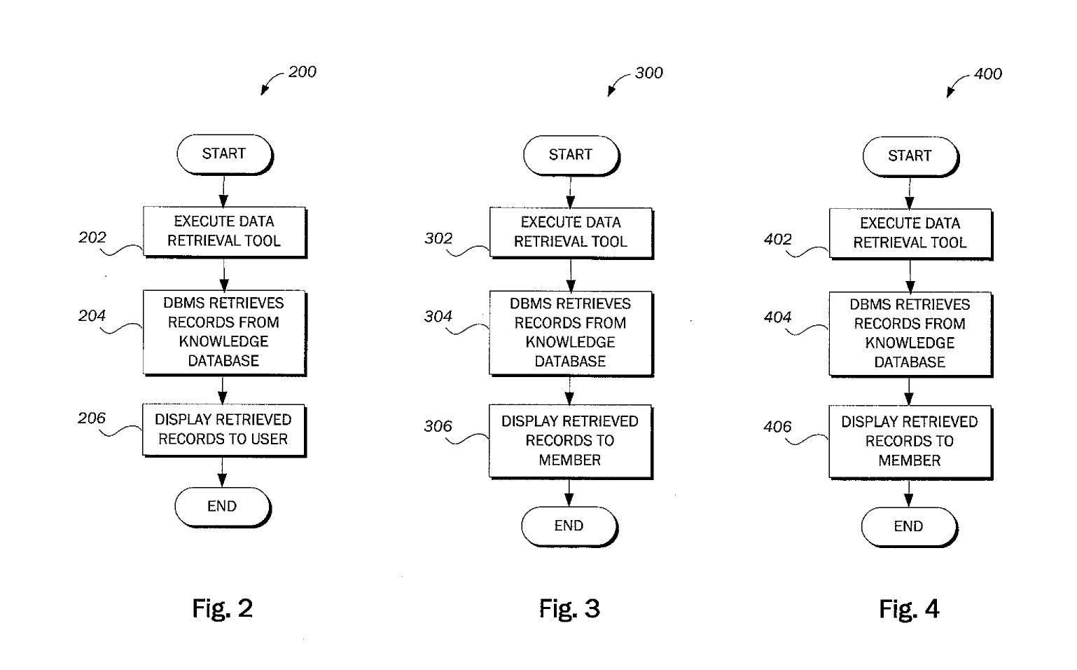

Reference is now made to FIG. 2, which shows a flow chart of a computer-based method 200 for personal, contextual knowledge management, in accordance with some embodiments. The present system may be configured to carry out method 200.

Method 200 is executed based, at least in part, on the knowledge database created in accordance with method 100 of FIG. 1. In a step 202, a user executes one or more data retrieval tools such as full-text search tools, semantic search tools, statistical engines, business intelligence tools, etc., in order to retrieve knowledge from the knowledge database. In a step 204, a database management system (DBMS) associated with the knowledge database retrieves records from the database based on the criteria provided to the data retrieval tools by the user. In a step 206, the retrieved records, which may include data and/or its contextual parameters, are displayed to the user. The user may then review the records, copy them to a document, and/or the like.

Reference is now made to FIG. 3, which shows a flow chart of a computer-based method 300 for organizational, contextual knowledge management, in accordance with some embodiments. The present system may be configured to carry out method 300.

Method 300 is executed based, at least in part, on multiple knowledge databases of multiple members of an organization, wherein each database was created in accordance with method 100 of FIG. 1. Alternatively, knowledge (or parts of it, based on permissions given by each member) stored in the multiple knowledge databases may be ported to a central organizational knowledge database, to which method 300 is applied. Further alternatively, a system used by an organization may include a central organizational knowledge database instead of personal, individual databases of members. For simplicity of presentation, the following discussion will utilize the singular term “knowledge database” to cover all the aforementioned alternatives.

In a step 302, a member of the organization executes one or more data retrieval tools such as full-text search tools, semantic search tools, statistical engines, business intelligence tools, etc., in order to retrieve knowledge created by the same member or other members, from the knowledge database. In a step 304, a database management system (DBMS) associated with the knowledge database retrieves records from the database based on the criteria provided to the data retrieval tools by the member. In a step 306, the retrieved records, which may include data and/or its contextual parameters, are displayed to the member. The member may then review the records, copy them to a document, and/or the like.

Reference is now made to FIG. 4, which shows a flow chart of a computer-based method 400 for global, contextual knowledge management, in accordance with some embodiments. The present system may be configured to carry out method 400.

Method 400 is executed based, at least in part, on multiple knowledge databases of multiple members of the public, such as Internet users, wherein each database was created in accordance with method 100 of FIG. 1. Alternatively, knowledge (or parts of it, based on permissions given by each member) stored in the multiple knowledge databases may be ported to a central, public knowledge database, to which method 400 is applied. Further alternatively, a system used as a global, Internet service may include a central knowledge database instead of personal, individual databases of members. For simplicity of presentation, the following discussion will utilize the singular term “knowledge database” to cover all the aforementioned alternatives.

In a step 402, a member of the public executes one or more data retrieval tools such as full-text search tools, semantic search tools, statistical engines, business intelligence tools, etc., in order to retrieve knowledge created by the same member or other members, from the knowledge database. As discussed above, usage of a semantic search engine in this scenario may be highly advantageous. In a step 404, a database management system (DBMS) associated with the knowledge database retrieves records from the database based on the criteria provided to the data retrieval tools by the member. In a step 406, the retrieved records, which may include data and/or its contextual parameters, are displayed to the member. The member may then review the records, copy them to a document, and/or the like.

When using a semantic search engine based on the present knowledge database, the user may relate to content and/or a contextual set of parameters for instructing the semantic search engine to retrieve desired knowledge. The request may be treated by the search engine as a query-by-example, thus enabling the search engine not just to find similarities in terms of dictionary/thesaurus resemblance, but also the relevant contextual nature of the query. For example, searching for “property” in the context of personal characteristics such as “student of geography”, document context such as “dissertation” and location context such as “Harvard University”, may retrieve a completely different set of relevant data that other contextual parameters such as “intellectual property expert” writing “provisional patent application” in “New-York law office”. The multi-dimensional nature of the database enables the search engine to quickly learn the profile of users and requests, thus exposing them to a parsimonious yet comprehensive outcome. The power of semantic search combined with the contextual knowledge database not only speeds-up and improves work efficiency, but may serve as an individual, group and global wisdom, exposing users to relevant knowledge pertaining to their fields of interest and even as a perpetual learning environment.

### Exemplary Implementation

An exemplary contextual knowledge management system (hereinafter the “exemplary system”) has been developed and experimented with. The exemplary system is software, based on the Microsoft .NET (dot net) framework, and was written in the C# programming language. The exemplary system includes two main modules: A client-side module and a server-side module. The client-side module is used for capturing data from the client's computer clipboard, and transmitting it to the server-side module. The server-side module is implemented as a cloud computing service, and enables user management, permissions, retaining of data, searching, displaying search results and the like.

The client-side module further includes a user registration mechanism, a mechanism for collecting data at the operating system level, such as clipboard data and contextual parameters, and a mechanism for non-intrusively and transparently transmitting the collected data to the server-side module.

The server-side module further includes sub-modules for inserting the collected data into a database and for conducting searches in the database. It further includes a user management sub-module, and a document-based database.

Upon initial execution of the client-side software, it collects and transmits contextual parameters, such as the user's identifying details, user name in the computer, work group, company, IP address and/or the like. The following is the data structure used in the exemplary system for working with the user's details:

```
public class ClientUserInformationModel
  {
    public string FirstName { get; set; }
    public string LastName { get; set; }
    public string UserName { get; set; }
    public string UserRole { get; set; }
    public string UserGroup { get; set; }
    public string UserOffice { get; set; }
    public long UserPermitions { get; set; }
  }
```

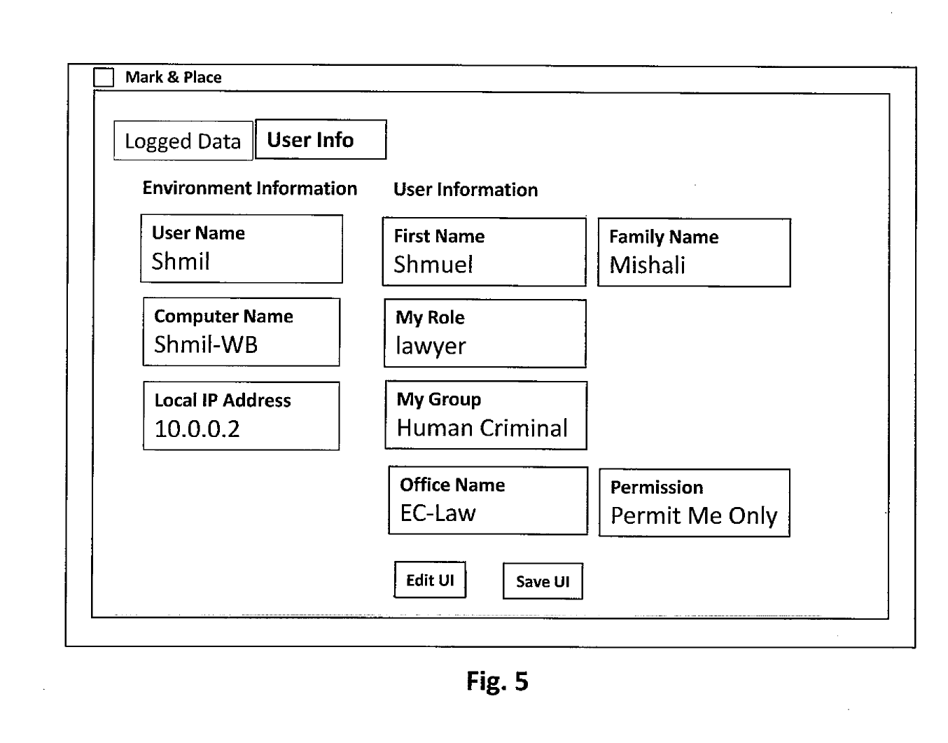

Some contextual parameters may be collected manually, by prompting the user to enter them. FIG. 5 shows a schematic illustration of a screenshot taken from the exemplary system, in which the data under “Environment Information” was collected automatically, and the data under “User Information” was manually entered by the user.

All the collected data is accumulated and transmitted to the server-side module according to the following data structure:

```
public class LogModel
{
  public string Data { get; set; }
  public string LocalIp { get; set; }
  public string MachineName { get; set; }
  public string UserName { get; set; }
  public string DomainName { get; set; }
  public string ProccessName { get; set; }
  public string MainWindowTitle { get; set; }
  public string Url { get; set; }
  public long UserPermitions { get; set; }
  public string Id { get; set; }
  public string RemoteIp { get; set; }
  public string UserOffice { get; set; }
  public string UserGroup { get; set; }
  public string CreatedOnShortString { get; set; }
  public DateTime CreatedOn { get; set; }
}
```

In order to collect some of the contextual parameters, the system utilizes a number of operating system API components available in C#, which enable the C# program to access certain parameters existing in and provided by the operating system.

In the exemplary system, the server-side module includes three layers: a RavenDB database, an application server (acting as middleware) and a front web interface based on Microsoft IIS.

The structure of the data table in the database is as follows:

```
public class LogModel
{
  public string Data { get; set; }
  public string LocalIp { get; set; }
  public string MachineName { get; set; }
  public string UserName { get; set; }
  public string DomainName { get; set; }
  public string ProccessName { get; set; }
  public string MainWindowTitle { get; set; }
  public string Url { get; set; }
  public long UserPermitions { get; set; }
  public string Id { get; set; }
  public string RemoteIp { get; set; }
  public string UserOffice { get; set; }
  public string UserGroup { get; set; }
  public string CreatedOnShortString { get; set; }
  public DateTime CreatedOn { get; set; }
}
```

Whereas the structure of the users table is:

```
public class UserInformationModel
{
  public string Id { get; set; }
  public DateTime CreatedOn { get; set; }
  public string CreatedOnShortString { get; set; }
  public string FirstName { get; set; }
  public string LastName { get; set; }
  public string UserName { get; set; }
  public string UserRole { get; set; }
  public string UserGroup { get; set; }
  public string UserOffice { get; set; }
  public long UserPermitions { get; set; }
}
```

The sub-module for conducting searches includes a search server connected to the database. The database includes a record index, enabling fast record retrieval. This sub-module is permissions-based, to enable a user to search for and view only the data at his or her permission level.

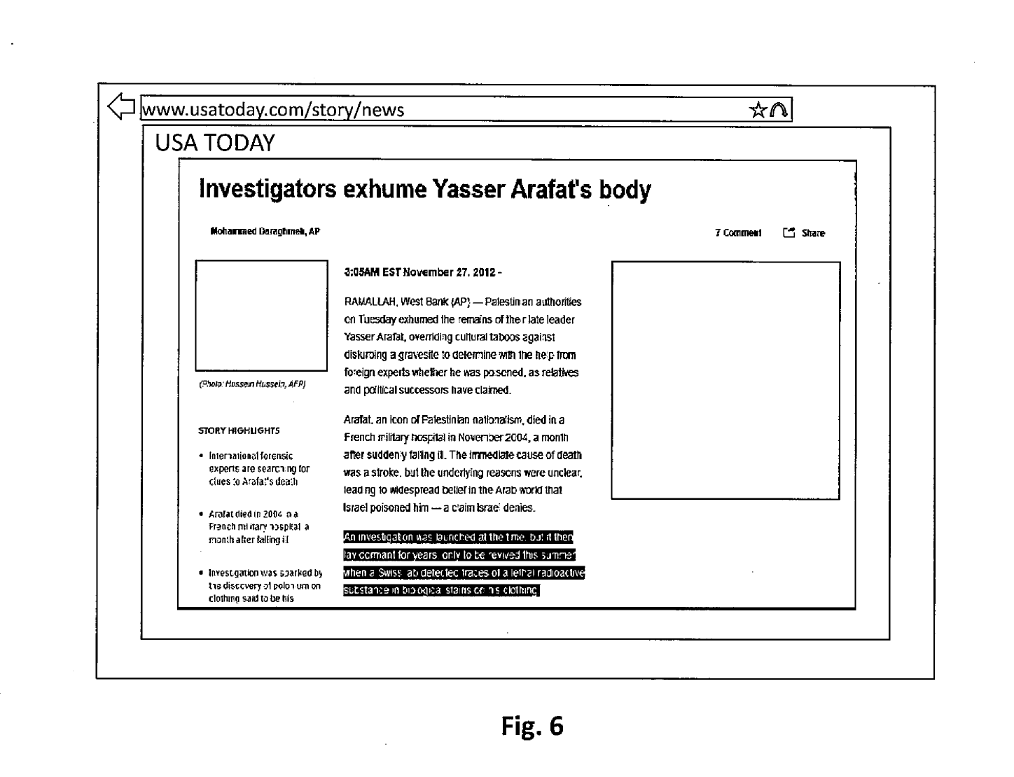

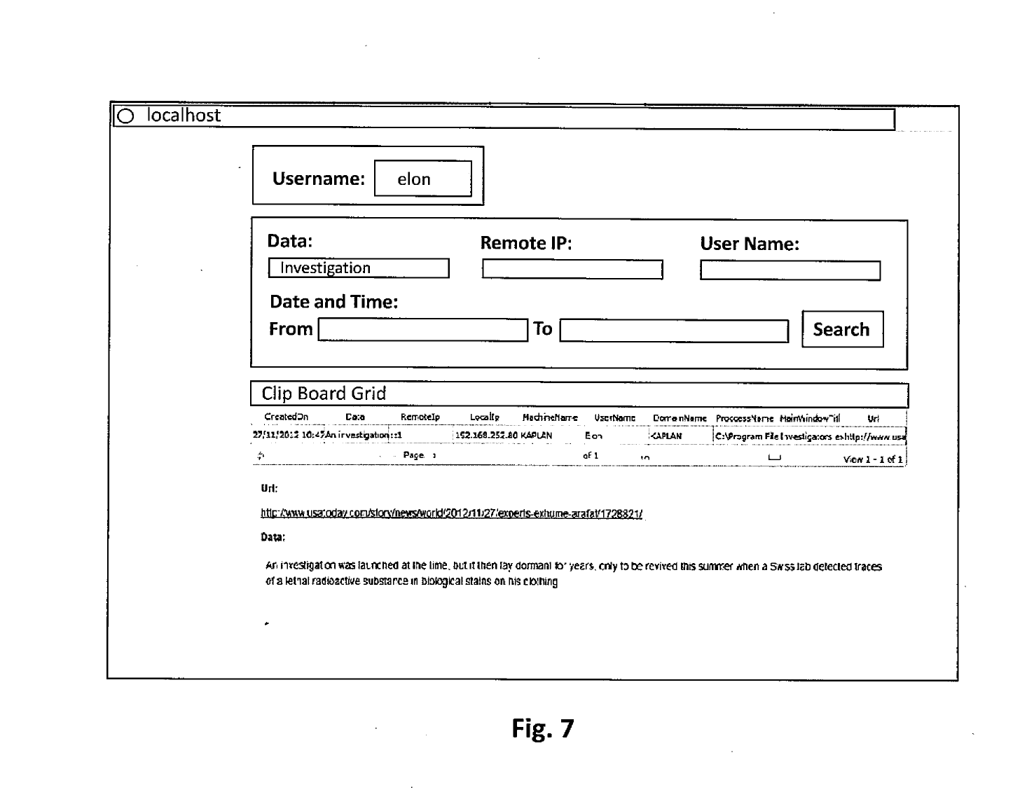

FIG. 6 shows an exemplary schematic illustration of a screenshot of a web page from the USA Today website, dated Nov. 27, 2012. The third paragraph in this webpage was highlighted by a user of the exemplary system, and copied into the computer's clipboard. FIG. 7 shows an exemplary schematic illustration of a screenshot of a “Clip Board Grid” of the exemplary system, which presents the various data collected by the exemplary system when the user had copied that paragraph from the USA Today website. The clip board grid shows the collected data, as well as some exemplary contextual parameters: created on, remote IP, local IP, machine name, user name, domain name, process name, main window title and URL.

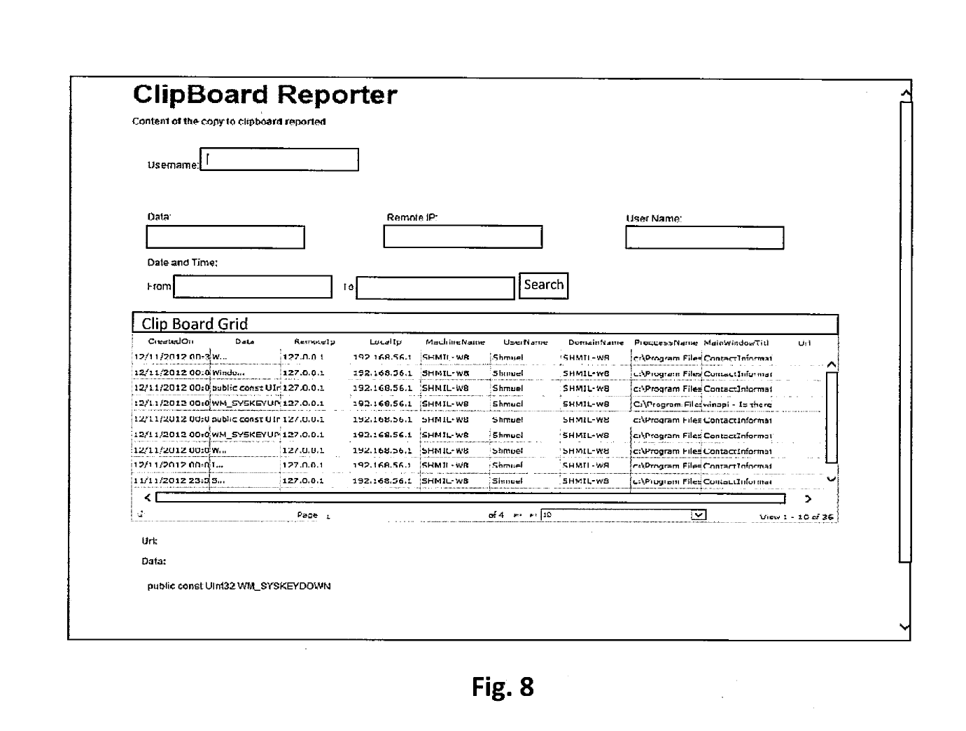

FIG. 8 shows another exemplary schematic illustration of a screenshot of the clip board grid, this time containing multiple entries of data collected.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

What is claimed is:

1. A computer-based method for personal knowledge management, the method comprising using one or more hardware processors for:
detecting copying of data from a source document by the user, on a computer;
intercepting the copied data in a clipboard of the computer;
collecting and storing in a knowledge database one or more contextual parameter associated with the copied data;
upon attempted pasting of the copied data by the user, injecting at least one of said one or more contextual parameter into the clipboard, such that when the copied data is pasted into a target document, said at least one of said one or more contextual parameter is pasted into the target document along with the copied data;
executing one or more data retrieval tools to retrieve knowledge from the knowledge database responsive to a query by the user; and
displaying one or more records retrieved from the knowledge database to the user.

2. The method according to claim 1, wherein said knowledge database is stored in a server accessible by the computer over a network.

3. The method according to claim 1, further comprising running a background service on the computer, wherein said detecting, intercepting, collecting and injecting are performed by said background service.

4. The method according to claim 1, wherein said source document comprises a web page.

5. The method according to claim 1, wherein said one or more contextual parameters are selected from the group consisting of: characteristics of a web page, characteristics of the target document, date, time, geographic location of the computer, characteristics of a software and/or a hardware of the computer and demographic characteristics of the user.

6. The method according to claim 1, wherein said collecting is performed fully-automatically, such that computer work of the user is not interrupted.

7. The method according to claim 1, wherein said collecting is performed semi-automatically, and comprises (a) background collecting of at least one of said one or more contextual parameter, and (b) receiving from the user, via manual input, other at least one of said one or more contextual parameter.

8. The method according to claim 7, further comprising retaining said other at least one of said one or more contextual parameter for future use, such that future collecting is performed fully-automatically.

9. The method according to claim 1, wherein said at least one of said one or more contextual parameter is pasted into the target document as text, said at least one of said one or more contextual parameter being a printable part of said target document.

10. The method according to claim 1, wherein said at least one of said one or more contextual parameter is pasted into the target document as hidden text, said at least one of said one or more contextual parameter not being a printable part of said target document.

11. The method according to claim 1, wherein said copied data is pasted into said target document such that to form an actionable link to said source document.

12. The method according to claim 1, wherein said copied data is pasted into said target document such that to form an actionable link to a location in said computer in which said copied data and said at least one of said one or more contextual parameter are stored.

13. The method according to claim 1, wherein said one or more data retrieval tools are selected from the group consisting of: full-text search tools, semantic search tools, statistical engines and/or business intelligence tools.

14. The method according to claim 1, wherein said one or more data retrieval tools is a semantic search engine.

15. The method according to claim 14, wherein said knowledge database is used for training said semantic search engine.

16. A computer-based method for organizational knowledge management, the method comprising:
(a) for each of multiple members of an organization:
detecting copying of data from a source document by a member of said multiple members the organization, on a computer;
intercepting the copied data in a clipboard of the computer;
collecting and storing in a knowledge database one or more contextual parameter associated with the copied data;
upon attempted pasting of the copied data by the member, injecting at least one of said one or more contextual parameter into the clipboard, such that when the copied data is pasted into a target document, said at least one of said one or more contextual parameter is pasted into the target document along with the copied data;
(b) executing one or more data retrieval tools to retrieve knowledge of at least some of said multiple members from the knowledge database, responsive to a query by a member of said multiple members; and
(c) displaying one or more records retrieved from the knowledge database to the member.

17. The method according to claim 16, wherein said one or more data retrieval tools is a semantic search engine.

18. A computer-based method for global knowledge management, the method comprising:
(a) for each of multiple Internet users:
detecting copying of data from a source document by a user of said Internet users, on a computer;
intercepting the copied data in a clipboard of the computer;
collecting and storing in a knowledge database one or more contextual parameter associated with the copied data;
upon attempted pasting of the copied data by the Internet users, injecting at least one of said one or more contextual parameter into the clipboard, such that when the copied data is pasted into a target document, said at least one of said one or more contextual parameter is pasted into the target document along with the copied data;
(b) executing one or more data retrieval tools to retrieve knowledge of at least some of said Internet users from the knowledge database, responsive to a query by user of said multiple Internet users; and
(c) displaying one or more records retrieved from the knowledge database to the user.

19. The method according to claim 18, wherein said one or more data retrieval tools is a semantic search engine.

20. The method according to claim 19, wherein said knowledge database is used for training said semantic search engine.
